(19) United States
(12) Patent Application Publication
(10) Pub. No.: US 2025/0267258 A1
(43) Pub. Date: Aug. 21, 2025

(54) DEVICE AND METHOD FOR ENCODING

(71) Applicant: SAMSUNG ELECTRONICS CO., LTD., Suwon-si, Gyeonggi-do (KR)

(72) Inventors: Hyuk Jae Jang, Suwon-si (KR); Jungyeop Yang, Suwon-si (KR); Jongseong Choi, Suwon-si (KR)

(21) Appl. No.: 19/046,171

(22) Filed: Feb. 5, 2025

(30) Foreign Application Priority Data
Feb. 21, 2024 (KR) 10-2024-0025268

(51) Int. Cl. H04N 19/117; H04N 19/146; H04N 19/184; H04N 19/196

(52) U.S. Cl. CPC H04N 19/117; H04N 19/146; H04N 19/196; H04N 19/184

(57) ABSTRACT

An encoding device includes an encoder and a controller. The encoder spatially filters image data based on a filter coefficient and encodes the filtered image data. The controller receives encoding information from the encoder and determines a variable parameter for adjusting the filter coefficient based on the encoding information.

### CROSS-REFERENCE TO RELATED APPLICATION

This application claims priority under 35 U.S.C. § 119 to Korean Patent Application No. 10-2024-0025268 filed on Feb. 21, 2024, in the Korean Intellectual Property Office, the disclosures of which are incorporated by reference herein in their entireties.

### BACKGROUND

When image data such as a video is encoded, a bitrate may be adjusted through a quantization parameter value. When data like a short video for a social network service are encoded at a relatively low bitrate and the quantization parameter value increases due to characteristics of the video, the image quality may be degraded. This also may cause a situation where the target bitrate is not satisfied even though a quantization parameter value is maximized.

### SUMMARY

Implementations of the present disclosure provide an encoding device capable of adaptively adjusting a filter coefficient and a method thereof.

According to implementations, an encoding device includes an encoder that spatially filters image data based on a filter coefficient and encodes the filtered image data, and a controller that receives encoding information from the encoder and determines a variable parameter for adjusting the filter coefficient based on the encoding information.

According to implementations, a method of an encoding device includes determining a variable parameter for adjusting a filter coefficient based on encoding information, calculating the filter coefficient based on the variable parameter, spatially filtering image data based on the filter coefficient, and encoding the filtered image data.

An encoding device includes a processing device, a memory device storing instructions that when executed by the processing device cause the encoding device to perform operations. The operations include determining a variable parameter for adjusting a filter coefficient based on encoding information, calculating the filter coefficient based on the variable parameter, spatially filtering image data based on the filter coefficient, and encoding the filtered image data.

### BRIEF DESCRIPTION OF THE DRAWINGS

The above and other objects and features of the present disclosure will become apparent by describing in detail implementations thereof with reference to the accompanying drawings.

FIG. 1 illustrates an example encoding device according to some implementations.

FIG. 2 illustrates an example encoding device according to some implementations.

FIG. 3 illustrates an example filter according to some implementations.

FIG. 4 illustrates an example filtering unit according to some implementations.

FIG. 5 illustrates an example transfer function of a filter according to some implementations.

FIG. 6 illustrates example 3D frequency characteristics of a filter transfer function according to some implementations.

FIG. 7 illustrates an example encoder according to some implementations.

FIG. 8 illustrates an example encoding device according to some implementations.

FIG. 9 is a flowchart of an example method of an encoding device according to some implementations.

FIG. 10 illustrates an example encoding device according to some implementations.

FIG. 11 is a flowchart of an example method of an encoding device according to some implementations.

FIG. 12 illustrates an example encoding device according to some implementations.

FIG. 13 illustrates an example operation of an encoding device depending on bit control information according to some implementations.

FIG. 14 illustrates an example encoding device according to some implementations.

FIG. 15 is a flowchart of an example method of an encoding device according to some implementations.

FIG. 16 illustrates an example encoding device according to some implementations.

FIG. 17 is a flowchart of an example method of an encoding device according to some implementations.

FIG. 18 to FIG. 20 are flowcharts of example bit control methods of an encoding device according to some implementations.

### DETAILED DESCRIPTION

Hereinafter, implementations of the present disclosure will be described clearly and in detail so that a person skilled in the technical field of the present disclosure may easily practice the implementations of the present disclosure.

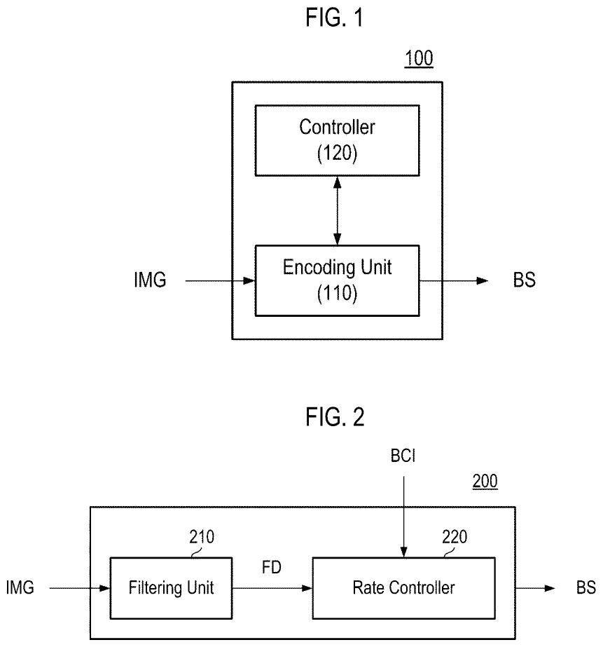

FIG. 1 illustrates an encoding device according to some implementations.

Referring to FIG. 1, an encoding device 100 may be configured to receive image data IMG and encode the received image data IMG. The encoding device 100 may be referred to as an “encoder”. The “image” of the image data IMG targeted for encoding may mean a frame, a picture, or a screen constituting a video, or may mean a video itself.

The encoding device 100 according to some implementations may include an encoding unit 110 and a controller 120.

The encoding unit 110 may spatially filter the image data IMG based on a filter coefficient and may encode the filtered image data FD.

For example, the spatial filtering may be a low pass filtering on the image data IMG. Through the spatial filtering, high-band components (e.g., edge components) of the image data IMG may be filtered. As the spatial filtering is applied more strongly, that is, as the number of filtered high-band components increases, encoding efficiency improves and a bitrate of a bit stream BS output through the encoding device 100 may be reduced. In addition, the quality of the image corresponding to the bit stream BS may be relatively degraded.

Alternatively, as the spatial filtering is applied more weakly, that is, as the number of filtered high-band components decreases, the encoding efficiency may deteriorate and the bitrate of the bit stream BS may increase. Additionally, the quality of the image corresponding to the bit stream BS may be relatively improved.

That the above-described spatial filtering is adjusted may mean that a cut-off frequency of the spatial filter used for the spatial filtering is adjusted. As the cut-off frequency increases relatively higher, the spatial filtering is weakly applied, and as the cut-off frequency decreases relatively lower, the spatial filtering may be strongly applied.

The above-described degree of spatial filtering, that is, the cut-off frequency of the filter may be determined based on the filter coefficient. That is, the degree of the spatial filtering performed by the encoding unit 110 may be determined depending on the value of the filter coefficient.

The encoding unit 110 may encode the image data IMG in response to a target bitrate on the filtered image data FD filtered through the spatial filtering. The encoding unit 110 may perform the encoding so that the target bitrate may be achieved based on several unit tools, unit operations, and unit algorithms.

In the present disclosure, the term “tool” may mean an element technology or an algorithm used for encoding and decoding an image. The encoding device 100 may perform the encoding based on one or more tools. For example, the tools may include tools related to image segmentation methods, tools used for predictive encoding/decoding, tools used for quantization/inverse quantization, tools used for transformation/inverse transformation, and tools used for filtering.

According to some implementations, the encoding unit 110 may encode the image data IMG per each encoding unit. The encoding unit may be referred to as a “block”, and one image data IMG may include a plurality of blocks.

The shape and size of the block may be variously determined depending on characteristics of the image and the encoding efficiency thereof. In addition, to encode a large amount of the image data IMG such as a high-resolution image or a high-definition image, the size of data units such as encoding units, prediction units, and transformation units may increase. The size of a macro block MB depending on a hierarchical structure based on a H.264 standard is 4×4, 8×8, and 16×16, but in the case of a high efficiency video coding (HEVC), a versatile video coding (VVC), and the like, the encoding device 100 may extend the size of the data units to 4×4, 8×8, 16×16, 32×32, 64×64, 128×128, and more, according to some implementations.

According to some implementations, the encoding unit 110 may perform the encoding at a buffer level. For example, the encoding unit 110 may buffer the bit stream BS obtained through the encoding for one or more image data IMG (e.g., a plurality of frames). The bit stream BS for one or more image data IMG may be accumulated through buffering, and the encoding unit 110 may transmit bit information according to the accumulation to the controller 120 as buffer level information.

The encoding unit 110 may output the bit stream BS corresponding to the image data IMG through the encoding.

When the encoding for one or more image data IMG is completed, the encoding unit 110 may output encoding information. For example, the encoding information may include bit generation information and the buffer level information.

The bit generation information may indicate the size of the bit stream BS output by the encoding unit 110 in response to the bitrate requested by the controller 120. When the size of the bit stream BS indicated by the bit generation information is lower than the required bitrate, the bitrate may be defined as “undershot”, and when the size of the bit stream BS is higher than the required bitrate, the bitrate may be defined as “overshot”. Of course, a threshold value for determining whether the bitrate is undershot or overshot may be applied, according to implementations. For example, a reference point of the undershot and the overshot may be defined as the threshold value applied to the required bitrate. That is, when the size of the bit stream BS exists within a range in which the threshold value is applied to the required bitrate, it may be regarded as neither undershot nor overshot.

The buffer level information may be defined as the bit information according to the buffering of the bit stream BS described above.

The controller 120 may control overall operation of the encoding unit 110. According to some implementations, the controller 120 may receive the encoding information according to the encoding from the encoding unit 110. The controller 120 may check the bitrate based on the encoding information and may determine a variable parameter for adjusting the filter coefficient. Because adjusting the filter coefficient means adjusting the cut-off frequency as described above, the variable parameter may ultimately control the degree of the spatial filtering through adjusting the cut-off frequency of the filter. The variable parameter may be determined in relation to the cut-off frequency of a prototype filter. The prototype filter is a filter basically used by the encoding unit 110 for the spatial filtering, and may be a filter having the cut-off frequency before being adjusted by the variable parameter.

For example, when the variable parameter is defined as “A”, ω_{c} is defined as an initial cut-off frequency of the prototype filter and Ω_{c} is defined as an adjusted cut-off frequency, the variable parameter may be determined based on Equation 1 below.

$$cos {ω}_{c} = A + ( 1 - A ) cos {Ω}_{c} \qquad [ Equation 1 ]$$

Here, Ω_{c} and ω_{c} may be any real numbers. The variable parameter “A” may be, for example, a value in the range of −a to a. For example, “A” may be 1 or some other non-zero real number. When the variable parameter A is adjusted, the cut-off frequency Ω_{c} of the filter may be adjusted and the filter coefficient for the filter may also be adjusted to have characteristics of corresponding cut-off frequency.

Using Equation 1 makes it possible that by adjusting only one variable parameter “A”, only the cut-off frequency may be changed while the frequency characteristics of a passing band, a transition band, or a blocking band of the prototype filter are maintained. This means that a desired filter may be easily obtained in real-time without time-consuming and complex filter redesign to obtain new cutoff frequencies.

According to some implementations, the controller 120 may determine whether the bitrate according to the encoding is overshot or undershot based on the encoding information. For example, the controller 120 may determine whether it is overshot or the undershot based on the size of the bit stream BS indicated by the bit generation information included in the encoding information and the size of the required bitrate.

The controller 120 may reduce the variable parameter based on whether the bitrate is overshot. The filter coefficient may be defined (or adjusted) to increase the cut-off frequency of the spatial filtering based on that the variable parameter relatively increases. Accordingly, because the degree of the spatial filtering is weakened, the encoding device 100 may satisfy the required bitrate while improving the image quality of the image.

Alternatively, the controller 120 may increase the variable parameter based on whether the bitrate is undershot. The filter coefficient may be defined (or adjusted) to reduce the cut-off frequency based on that the variable parameter relatively decreases. Accordingly, because the degree of the spatial filtering increases, the encoding device 100 may satisfy the required bitrate instead of reducing the image quality of the image.

According to the above-described implementations, the encoding device 100 of the present disclosure may adaptively adjust the filter coefficient to be used for the spatial filtering for encoding input image data IMG based on the variable parameter. The filter for the spatial filtering has a fixed cut-off frequency as it is designed, and it is difficult to adjust the cut-off frequency in real-time by modifying the design of the filter itself. Through determining whether the bitrate is satisfied based on the encoding information according to the encoding and adjusting the variable parameter for controlling the filter coefficient depending on whether the bitrate is satisfied, the encoding device 100 of this disclosure may adjust the degree of the spatial filtering in real-time.

In particular, a scenario which requires relatively low bitrate encoding (e.g., a short video of a social network service (SNS), a video call) has an issue with poor image quality or not satisfying the target bitrate according to the encoding due to the characteristics of the scenario. The encoding device 100 of the present disclosure may satisfy the target bitrate while maintaining or improving the image quality by adjusting the degree of the spatial filtering separately from the encoding in the low bitrate scenario.

FIG. 2 illustrates an encoding device according to some implementations.

Referring to FIG. 2, an encoding device 200 according to some implementations may include a filtering unit 210 and a rate controller 220, according to some implementations. According to implementations, the encoding device 200 of FIG. 2 may correspond to the encoding unit 110 of FIG. 1.

The filtering unit 210 may receive the image data IMG, and may output the filtered image data FD by performing the spatial filtering on the image data IMG. For example, the filtering unit 210 may be implemented as a 2D spatial filter. For example, the filtering unit 210 may be implemented as a low pass filter (LPF).

The filtering unit 210 may perform the spatial filtering through the filter having the cut-off frequency and the filter coefficient adjusted through the variable parameter, according to the above-described implementations.

The rate controller 220 may encode the filtered image data FD output from the filtering unit 210. The rate controller 220 may perform the encoding so that the target bitrate may be achieved based on the above-described encoding tools. At least some of the tools may perform the encoding according to bit control information BCI. The bit control information BCI may be used to indicate an operation mode of each tool to satisfy the target bitrate. Each of the tools may operate so that the bit stream BS to be finally output may have a higher or a lower bitrate, according to the indicated operation mode.

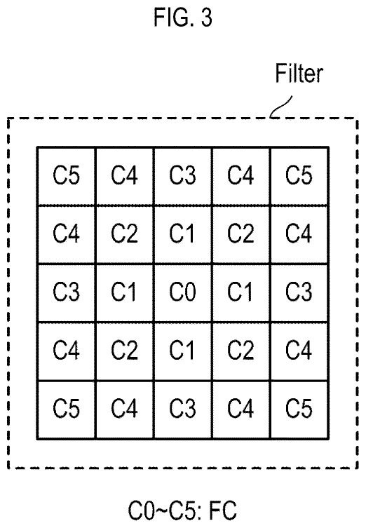

FIG. 3 illustrates a filter according to some implementations.

Referring to FIG. 3, the filter may be defined as including at least one filter coefficient FC. The filter may have a size corresponding to the filtering unit. Assuming that the size of the filtering unit is N (N is a natural number), FIG. 3 illustrates a filter for N=5 as an example. As illustrated, the filter may have a mask form having the size corresponding to the filtering unit. For example, the filtering unit may be the same as the encoding unit described above.

Each element of the filter may correspond to the filter coefficient FC. The filter may be implemented to include the filter coefficient FC which is symmetrical with respect to the center of the mask as illustrated. Alternatively, each element may have the filter coefficient FC different from each other.

One or more filter coefficients FC may be defined, and each may be adjusted according to the variable parameter of the above-described implementations. The filter coefficient FC may be calculated and defined in units of one image data.

According to some implementations, scaling may be applied to the calculation of the filter coefficient FC. The scaling may involve multiplying predetermined scaling parameters by variables (e.g., the variable parameter) used to calculate the filter coefficient FC, or applying the scaling parameters to the calculation of the filter coefficient FC through other mathematical operations. When upscaling is applied, the calculation or adjustment process of the filter coefficient FC may be implemented as a shift-based operation rather than a product operation.

The encoding unit of FIG. 1 or the filtering unit of FIG. 2 may perform the spatial filtering while applying the filter according to the above-described implementations in units of pixels included in image data. For example, the encoding unit may apply the filter coefficient C0 corresponding to center of the filter to the target pixel, and apply remaining filter coefficients C1 to C5 to surrounding pixels of the target pixel.

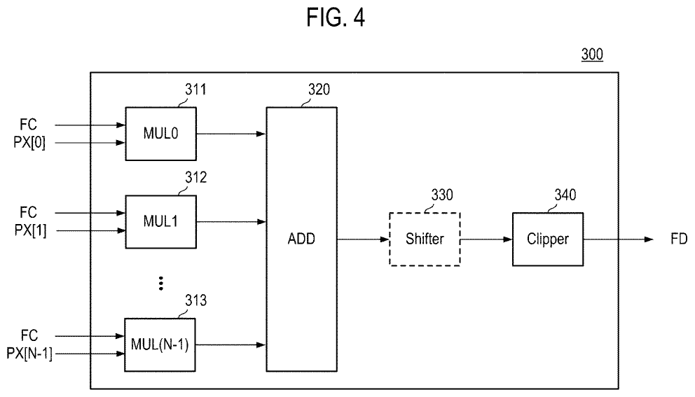

FIG. 4 illustrates a filtering unit according to some implementations.

Referring to FIG. 4, a filtering unit 300 according to some implementations may include a plurality of multipliers 311 to 313, an adder 320, and a clipper 340.

The multipliers 311 to 313 may receive the filter coefficient FC and unit pixels PX[0] to PX[N−1] included in the image data. For example, the multipliers 311 to 313 may be provided as many times as the size N of the filtering unit. The multipliers 311 to 313 may perform the product operation on the unit pixels PX[0] to PX[N−1] and the filter coefficient FC corresponding to the unit pixels PX[0] to PX[N−1], and output the result of the product operation to the adder 320.

The adder 320 may receive the result of the product operation from the plurality of multipliers 311 to 313 and perform a sum operation on the received results of the product operation. The adder 320 may output the result of the sum operation.

According to some implementations, the filtering unit 300 may further include a shifter 330. The shifter 330 may perform a shift operation on the result of the sum operation output from the adder 320. The shift operation is to move data in a bit string by a specific number of bits in a specific direction (left or right). When scaling is applied to the filter coefficient FC, the shifter 330 may perform a shift operation to restore the scaled value to the original scale. That is, the number of specific bits corresponding to the size of the shift operation may be defined to offset the scaling of the filter coefficient FC.

The clipper 340 may perform clipping on data output from the adder 320 or the shifter 330. The clipping is to cut out excess data when the output data exceeds the size of the unit pixels PX[0] to PX[N−1]. For example, when the unit pixels PX[0] to PX[N−1] are 8 bits (or 10 bits), the clipper 340 may clip a part of the output data which exceeds 8 bits (or 10 bits). Through the clipping, finally the filtered image data FD may be output.

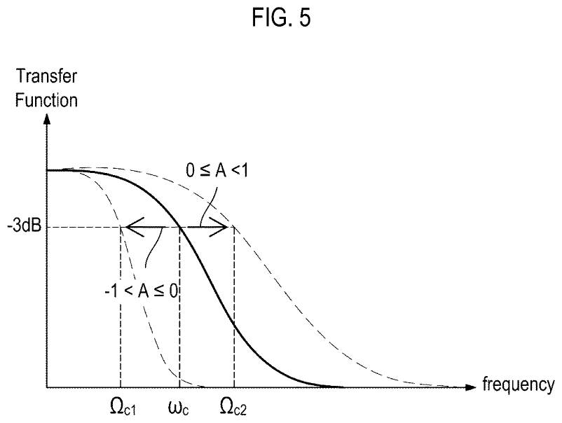

FIG. 5 illustrates amplitude response characteristics of a filter transfer function according to some implementations.

Referring to FIG. 5, the filter may be used through the encoding unit (or the filtering unit) for the spatial filtering, according to the above-described implementations. The filter may be designed with an initial cut-off frequency ω_{c}.

The initial cut-off frequency ω_{c} may be adaptively adjusted as the variable parameter “A” is adjusted. For example, when the bitrate is overshot, the variable parameter “A” and the filter coefficient may be adjusted to further reduce the cut-off frequency of the filter. In this case, the variable parameter “A” may be adjusted to have a value between −1 and 0 as illustrated, and the initial cut-off frequency ω_{c} may be reduced to the adjusted cut-off frequency Ωc₁. As the variable parameter “A” decreases further (i.e., as an absolute value of the variable parameter “A” increases), the adjusted cut-off frequency Ωc₁ may gradually decrease. Therefore, the degree of the spatial filtering through the filter may be set more strongly.

As a result, when the bitrate is overshot, the target bitrate may be satisfied by suppressing the amount of bits generated by adjusting the variable parameter “A”.

For example, when the bitrate is undershot, the variable parameter “A” and the filter coefficient may be adjusted to further increase the cut-off frequency of the filter. In this case, the variable parameter “A” may be adjusted to have a value between 0 and 1 as illustrated, and the initial cut-off frequency ω_{c} may be increased to the adjusted cut-off frequency Ωc₂. As the variable parameter “A” further increases, the adjusted cut-off frequency Ωc₁ may gradually increase. Therefore, the degree of the spatial filtering through the filter may be set more weakly.

As a result, when the bitrate is undershot, the image quality may be improved within the target bitrate by increasing the amount of bits generated by adjusting the variable parameter “A”.

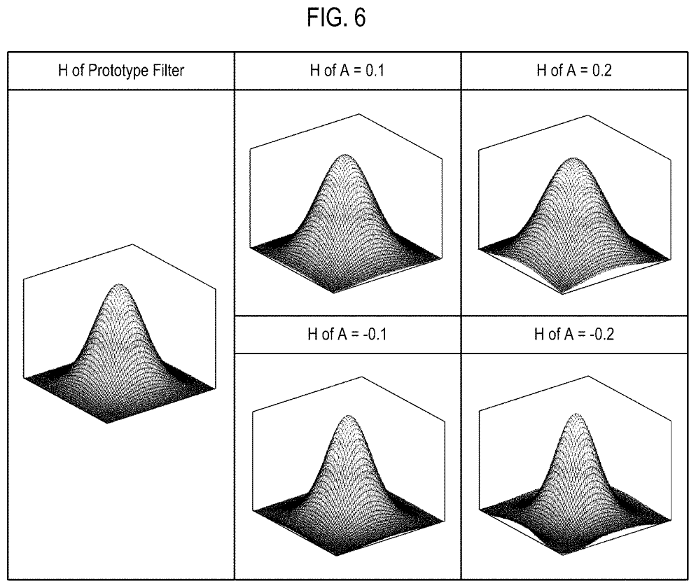

FIG. 6 illustrates a 3D amplitude response frequency characteristic of the filter transfer function according to some implementations.

Referring to FIG. 6, it may be seen that the frequency characteristics of the filter become wider as the variable parameter “A” gradually increases (A=0.1, A=0.2). On the other hand, it may be seen that as the variable parameter “A” gradually decreases (A=−0.1, −0.2), the frequency characteristics of the filter becomes sharper. In other words, as the variable parameter “A” increases, the degree of the spatial filtering becomes weaker, and higher frequency components may exist in the image data. On the other hand, as the variable parameter “A” decreases, the degree of the spatial filtering becomes stronger, and high frequency components in the image data may be reduced.

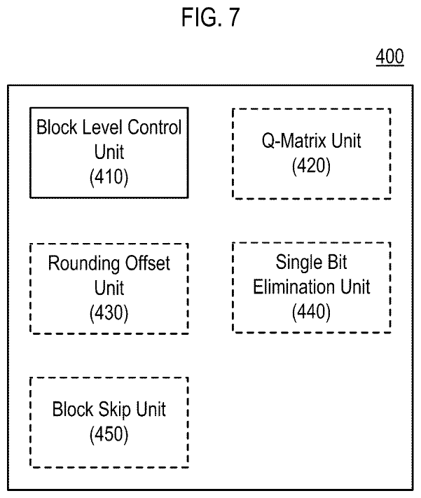

FIG. 7 illustrates an encoding unit according to some implementations.

Referring to FIG. 7, an encoding unit 400 according to some implementations may include a block level control unit 410. In addition, the encoding unit 400 may include at least some of a Q-matrix unit 420, a rounding offset unit 430, a single bit elimination unit 440, and a block skip unit 450.

The block level control unit 410 may control the bitrate for each block, which is an encoding unit. According to some implementations, the block level control unit 410 may control a quantization parameter QP used for the encoding. The quantization parameter may mean a value used to generate a transform coefficient level for a transform coefficient in quantization. Alternatively, the quantization parameter may refer to a value used to generate a transformation coefficient by scaling a transform coefficient level in the inverse quantization. Alternatively, the quantization parameter may be a value mapped to a quantization step size.

The transformation coefficient may be a coefficient value generated by performing transformation in the encoding device. Alternatively, the transformation coefficient may be a coefficient value generated by performing at least one of entropy decoding and inverse quantization in the decoding device.

The block level control unit 410 may satisfy the target bitrate by adjusting the quantization parameter in units of blocks. For example, when the bitrate of the bit stream is high, the block level control unit 410 may increase the quantization parameter, and when the bitrate is low, the block level control unit 410 may decrease the quantization parameter.

According to some implementations, the block level control unit 410 may generate and transmit a control signal for controlling at least some of the Q-matrix unit 420, the rounding offset unit 430, the single bit elimination unit 440, and the block skip unit 450 included in the encoding unit 400.

The Q-matrix unit 420 may perform quantization based on a Q-matrix. The Q-matrix may be called a quantization matrix. The Q-matrix may mean a matrix used in a quantization process or an inverse quantization process to improve a subjective image quality or an objective image quality of an image. Each element included in the quantization matrix may correspond to a quantization matrix coefficient, and the quantization matrix coefficient may correspond to the above-described quantization parameter.

The rounding offset unit 430 may add a rounding offset to the quantization parameter. The rounding offset may be an adjustment value for rounding calculation when a rounding function is used for the quantization parameter.

When a single bit remains in the data quantized through the Q-matrix unit 420, the single bit elimination unit 440 may remove or leave the single bit. For example, the single bit elimination unit 440 may leave a bit when there is a bit margin for the target bitrate, and may remove the bit when there is no bit margin for the target bitrate.

The block skip unit 450 may determine whether a specific encoding unit is skipped or not according to the encoding. Likewise, the block skip unit 450 may determine whether the specific encoding unit is skipped or not according to the target bitrate.

In addition to the above-described configurations, the encoding unit 400 may further include various configurations capable of adjusting the bitrate.

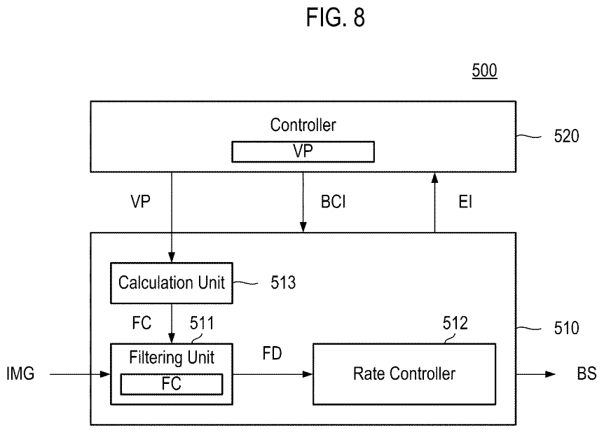

FIG. 8 illustrates an encoding device according to some implementations.

Referring to FIG. 8, in an encoding device 500 according to some implementations, an encoding unit 510 may calculate the filter coefficient FC in real-time based on a variable parameter VP. In addition to a filtering unit 511 and a rate controller 512, the encoding unit 510 may further include a calculation unit 513 for calculating the filter coefficient FC.

Specifically, the encoding unit 510 may perform the spatial filtering on the image data IMG through the filtering unit 511 to output the filtered image data FD, and the rate controller 512 may perform the encoding on the filtered image data FD to output the bit stream BS. When the encoding for one or more image data IMG is terminated, the encoding unit 510 may transmit encoding information EI for the encoding result to a controller 520.

The controller 520 may check the bitrate through the encoding information EI and determine the variable parameter VP. The controller 520 may transmit the determined variable parameter VP to the calculation unit 513. According to some implementations, the controller 520 may reduce the cut-off frequency of the filter by reducing the variable parameter VP when the bitrate is overshot, and may increase the cut-off frequency by increasing the variable parameter VP when the bitrate is undershot. In this case, even though the encoding unit 510 increases the quantization parameter for stronger encoding (or uses the maximum value quantization parameter), the controller 520 may reduce the variable parameter VP to reduce the cut-off frequency when the bitrate is overshot.

In addition, the controller 520 may generate the bit control information BCI for controlling the bitrate according to the encoding based on the encoding information EI and may transmit the bit control information BCI to the encoding unit 510. According to some implementations, the controller 520 may determine whether the bitrate according to the encoding is overshot or undershot based on the encoding information EI, and may generate the bit control information BCI according to the overshoot or the undershoot. For example, when the bitrate is overshot, the controller 520 may generate the bit control information BCI so that the rate controller 512 operates in a direction of reducing the bitrate. Alternatively, when the bitrate is undershot, the controller 520 may generate the bit control information BCI so that the rate controller 512 operates in a direction of increasing the bitrate.

The encoding unit 510 may encode the filtered image data FD based on the received bit control information BCI.

The encoding unit 510 may receive the variable parameter VP from the controller 520 through the calculation unit 513 and may calculate the filter coefficient FC based on the variable parameter VP. According to some implementations, the calculation unit 513 may calculate the filter coefficient FC based on at least one of the variable parameter VP, a basic filter setting value, and the scaling parameter. The variable parameter VP may be defined as a sign bit “m” (m is a natural number), and a value of 2^{m} represented by the sign bit may represent any one of values to be used for actual calculation.

The basic filter setting value may be defined as an impulse response (or transfer function) of the above-described basic filter, and a plurality of basic filter setting values may be defined corresponding to the number of basic filters.

According to some implementations, the calculation unit 513 may calculate the filter coefficient FC based on adjusting the basic filter setting value according to the variable parameter VP.

According to some implementations, the calculation unit 513 may calculate the filter coefficient FC based on a k-order polynomial (k is an integer greater than or equal to 0) with the variable parameter VP as a variable. Each coefficient of the k-order polynomial may be defined based on at least one of the scaling parameter and the basic filter setting value.

According to some implementations, the calculation unit 513 may calculate the filter coefficient FC based on a polynomial in which each term is defined as a different basic filter setting value. Each coefficient of the polynomial may be defined based on at least one of the scaling parameter and the variable parameter VP.

The calculation unit 513 may calculate the filter coefficient FC based on the polynomial defined differently for each of several filter coefficients FC (e.g., C0 to C5 of FIG. 3) included in the filter.

The calculation unit 513 may transmit the calculated filter coefficient FC to the filtering unit 511, and the filtering unit 511 may perform the spatial filtering based on the received filter coefficient FC.

According to some implementations, the calculation unit 513 may apply scaling to calculations. The filtering unit 511 may apply a shift according to the scaling to the filtered image data FD.

As a result, according to the above-described implementations, the controller 520 included in the encoding device 500 of the present disclosure may determine the variable parameter VP and transmit the variable parameter VP to the encoding unit 510, and the encoding unit 510 may calculate the filter coefficient FC. Accordingly, a load on the calculation of the filter coefficient FC of the controller 520 may be reduced.

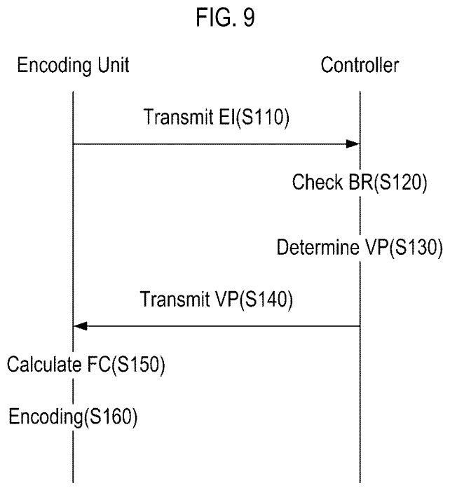

FIG. 9 is a flowchart of a method of an encoding device according to some implementations.

Referring to FIG. 9, in operation S110, the encoding unit may transmit to the controller the encoding information EI according to the encoding. In operation S120, the controller may receive the encoding information EI from the encoding unit and may check a bitrate BR based on the received encoding information EI. In this case, the controller may compare the bitrate BR indicated by the encoding information EI with the target bitrate and determine whether the bitrate BR is overshot or undershot. In operation S130, the controller may determine the variable parameter VP according to whether the bitrate BR is overshot or undershot. In operation S140, the controller may transmit the determined variable parameter VP to the encoding unit.

In operation S150, the encoding unit may calculate the filter coefficient FC based on the variable parameter VP received from the controller. The filter coefficient FC may be calculated to further reduce the cut-off frequency of the filter when the bitrate is overshot. Alternatively, the filter coefficient FC may be calculated to further increase the cut-off frequency of the filter when the bitrate is undershot.

In operation S160, the encoding unit may perform the encoding based on the calculated filter coefficient FC.

According to the above-described implementations, in the case of the method of the encoding device of the present disclosure, because the controller determines only the variable parameter VP and transmits the variable parameter VP to the encoding unit, the load on the filter coefficient FC calculation of the controller may be reduced.

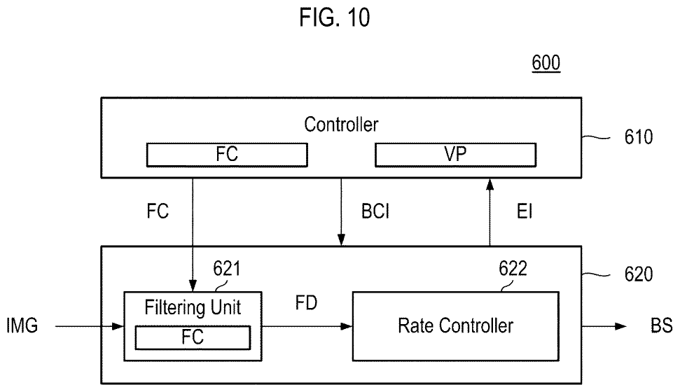

FIG. 10 illustrates an encoding device according to some implementations.

Referring to FIG. 10, in the encoding device according to some implementations, a controller 610 may determine the variable parameter VP and calculate the filter coefficient FC based on the determined variable parameter VP. That is, unlike FIG. 8, in the case of the encoding device of FIG. 10, the controller 610 may perform the calculation of the filter coefficient FC. In this case, an encoding unit 620 may receive the filter coefficient FC from the controller 610 and perform the spatial filtering on the image data IMG by using the received filter coefficient FC.

Specifically, the encoding unit 620 may perform the spatial filtering on the image data IMG through a filtering unit 621 to output the filtered image data FD, and a rate controller 622 may perform the encoding on the filtered image data FD to output the bit stream BS. The encoding unit 620 may transmit the encoding information EI for the encoding result to the controller 610.

The controller 610 may check the bitrate through the encoding information EI and determine the variable parameter VP. As described above, the controller 610 may adjust the variable parameter VP and the cut-off frequency according to whether the bitrate is overshot or undershot. In this case, even though the encoding unit 620 increases the quantization parameter for stronger encoding (or uses the maximum value quantization parameter), the controller 610 may reduce the variable parameter VP to reduce the cut-off frequency when the bitrate is overshot.

The controller 610 may calculate the filter coefficient FC based on the determined variable parameter VP. As illustrated in FIG. 10, the controller 610 may calculate the filter coefficient FC based on at least one of the variable parameter VP, the basic filter setting value, and the scaling parameter. For example, the controller 610 may calculate the filter coefficient FC based on adjusting the basic filter setting value according to the variable parameter VP. For example, the controller 610 may calculate the filter coefficient FC based on the polynomial having the variable parameter VP as a variable. For example, the controller 610 may calculate the filter coefficient FC based on a polynomial in which each term is defined as a default filter setting value different from each other.

According to some implementations, the controller 610 may apply scaling to the calculation.

The controller 610 may transfer the calculated filter coefficient FC to the encoding unit 620. Additionally, the controller 610 may generate and transmit the bit control information BCI for controlling the bitrate according to the encoding to the encoding unit 620, based on the encoding information EI.

When the encoding unit 620 receives the filter coefficient FC on which the calculation is already completed from the controller 610, the encoding unit 620 may immediately perform the spatial filtering based on the received filter coefficient FC. According to some implementations, the encoding unit 620 may apply a shift according to the scaling to the filtered image data FD.

Consequently, according to the above-described implementations, the controller 610 included in the encoding device of the present disclosure determines and transmits both the variable parameter VP and the filter coefficient FC to the encoding unit 620, and the encoding unit 620 only performs the spatial filtering. Accordingly, the load on the calculation of the filter coefficient FC of the encoding unit 620 may be reduced.

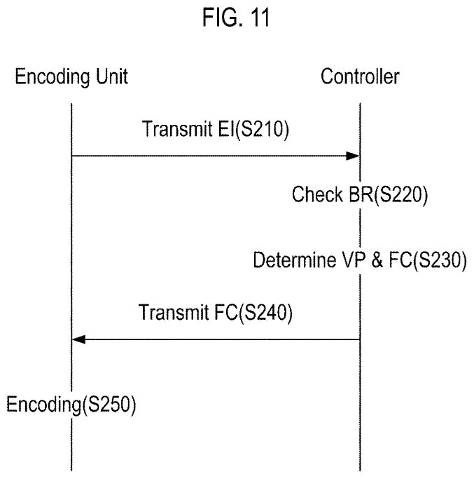

FIG. 11 is a flowchart of a method of an encoding device according to some implementations.

Referring to FIG. 11, in operation S210, the encoding unit may transmit to the controller the encoding information EI according to the encoding. In operation S220, the controller may receive the encoding information EI from the encoding unit and may check the bitrate BR based on the received encoding information EI. In operation S230, the controller may determine the variable parameter VP according to whether the bitrate BR is overshot or undershot. In addition, the controller may calculate the filter coefficient FC based on the variable parameter VP in operation S230. That is, the controller may determine both the variable parameter VP and the filter coefficient FC.

In operation S240, the controller may transmit the determined filter coefficient FC to the encoding unit. In operation S250, the encoding unit may perform the encoding based on the filter coefficient FC received from the controller.

According to the above-described implementations, in the case of the method of the encoding device of the present disclosure, because the controller calculates the filter coefficient FC and transmits the filter coefficient FC to the encoding unit, the load on the filter coefficient FC calculation of the encoding unit may be reduced.

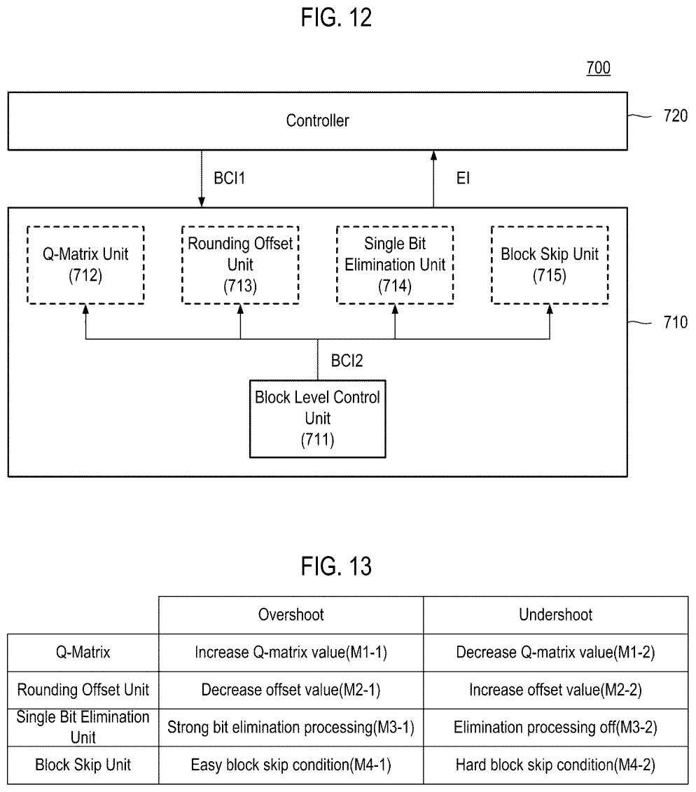

FIG. 12 illustrates an encoding device according to some implementations, and FIG. 13 illustrates an operation of the encoding device based on the bit control information according to some implementations.

Referring to FIG. 12, an encoding unit 710 of an encoding device 700 may include a block level control unit 711, and may also include at least some of a Q-matrix unit 712, a rounding offset unit 713, a single bit elimination unit 714, and a block skip unit 715.

The encoding unit 710 transmits the encoding information EI according to the encoding to a controller 720, and the controller 720 may determine whether the bitrate is overshot or undershot based on the encoding information EI, and may generate first bit control information BCI1 according to the overshoot or the undershoot. In this case, the encoding information EI may include one image data, for example, the bit generation information for one frame. Accordingly, the first bit control information BCI1 may include control information required for encoding one frame.

The block level control unit 711 may generate second bit control information BCI2 which is control information required for a unit smaller than one frame, for example, an encoding unit such as a block. The block level control unit 711 may transmit the generated second bit control information BCI2 to the Q-matrix unit 712, the rounding offset unit 713, the single bit elimination unit 714, and the block skip unit 715.

The Q-matrix unit 712, the rounding offset unit 713, the single bit elimination unit 714, and the block skip unit 715 may perform the encoding based on the first bit control information BCI1 and/or the second bit control information BCI2. The operation modes of the Q-matrix unit 712, the rounding offset unit 713, the single bit elimination unit 714, and the block skip unit 715 may be determined according to the first bit control information BCI1 and/or the second bit control information BCI2.

Referring to FIG. 13, the Q-matrix unit 712, the rounding offset unit 713, the single bit elimination unit 714, and the block skip unit 715 may operate in a specific operation mode according to the first bit control information BCI1 and/or the second bit control information BCI2. Each of the components (the Q-matrix unit 712, the rounding offset unit 713, the single bit elimination unit 714, and the block skip unit 715) may determine an operation mode with reference to each control information.

First, the Q-matrix unit 712 may operate in a 1-1st operation mode M1-1 or a 1-2nd operation mode M1-2 according to the first bit control information BCI1 and/or the second bit control information BCI2. For example, the Q-matrix unit 712 may operate in the 1-1st operation mode M1-1 which increases a value of the Q-matrix when the bitrate is overshot. For example, when the bitrate is undershot, the Q-matrix unit 712 may operate in the 1-2nd operation mode M1-2 in which the value of the Q-matrix is reduced. In the 1-1st operation mode M1-1, the Q-matrix unit 712 may quantize the image data in a direction to further reduce the bitrate by increasing the value of the Q-matrix. In the 1-2nd operation mode M1-2, the Q-matrix unit 712 may quantize the image data in a direction where the bitrate is further increased by reducing the value of the Q-matrix.

The rounding offset unit 713 may add the rounding offset to the quantization parameter.

The single bit elimination unit 714 may operate in a 3-1st operation mode M3-1 or a 3-2nd operation mode M3-2 according to the first bit control information BCI1 and/or the second bit control information BCI2. In the 3-1st operation mode M3-1, the single bit elimination unit 714 may further reduce the bitrate by removing the single bit. In the 3-2nd operation mode M3-2, the single bit elimination unit 714 may leave a single bit so that the bitrate may be further increased.

The block skip unit 715 may operate in a 4-1st operation mode M4-1 or a 4-2nd operation mode M4-2 according to the first bit control information BCI1 and/or the second bit control information BCI2. In the 4-1st operation mode M4-1, the block skip unit 715 may relatively alleviate a block skip condition so that more blocks are skipped. In the 4-2nd operation mode M4-2, the block skip unit 715 may relatively enhance the block skip condition, so that fewer blocks are skipped. The fewer block skips are generated, the more bitrate may be increased.

According to the above-described implementations, the encoding device of the present disclosure may adaptively adjust the bitrate by controlling the components for a rate control according to whether the bitrate of the encoding is overshot or undershot.

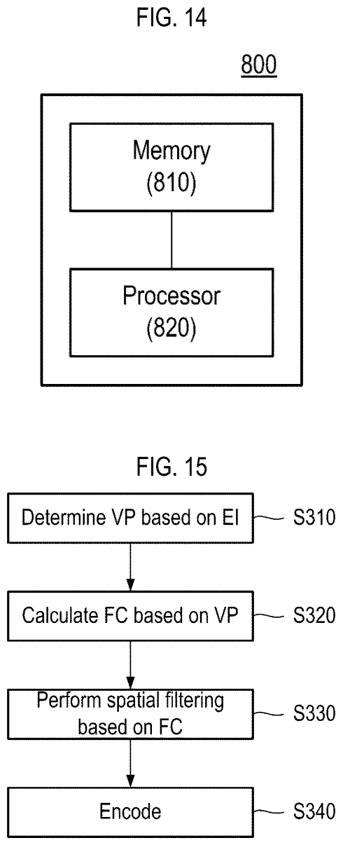

FIG. 14 illustrates an encoding device according to some implementations.

Referring to FIG. 14, an encoding device 800 according to some implementations may include a memory 810 and a processor 820. One or more of the memory 810 may be provided, and one or more of the processor 820 may be provided.

The memory 810 may be connected to the processor 820 to store instructions to be executed by the processor 820. The memory 810 may be widely interpreted to include any electronic component capable of storing electronic information. The memory 810 may refer to various types of processor-readable media such as a random access memory (RAM), a read-only memory (ROM), a non-volatile random access memory (NVRAM), a programmable read-only memory (PROM), an erase-programmable read-only memory (EPROM), an electrically erasable PROM (EEPROM), a flash memory, a magnetic or optical data storage, and registers.

The processor 820 may be broadly interpreted to include a general-purpose processor, a central processing unit (CPU), a microprocessor, a digital signal processor (DSP), a controller, a microcontroller, a state machine, and the like. In addition, the processor 820 may refer to an on-demand semiconductor or an application specific integrated circuit (ASIC), a programmable logic device (PLD), a field programmable gate array (FPGA), and the like. In addition, the processor 820 may refer to, for example, a combination of DSP and microprocessors, a combination of multiple microprocessors, a combination of one or more microprocessors combined with the DSP core. The processor 820 may also refer to a combination of processing devices such as a combination of a DSP and a microprocessor, a combination of a plurality of microprocessors, a combination of one or more microprocessors in combination with a DSP core, or any other such combination of configurations.

According to various implementations of the present disclosure, the above-described “unit”, “controller”, and/or “device” may be implemented with one or more processors 820 and one or more memories 810. Accordingly, the encoding device 800 and the operations of the components included in the encoding device 800 may be operated as an individual processor or may be operated under the control of the central processor, according to the above-described implementations.

The memory 810 may store data received from the outside of the encoding device 800 and data generated by the processor 820. For example, the memory 810 may store the target bitrate, the image data, the bit stream, the variable parameter, the filter coefficient, the encoding information, the bit control information, and the like according to the above-described implementations.

According to some implementations, the processor 820 may spatially filter the image data based on the filter coefficient and may encode the filtered image data. The processor 820 may determine the variable parameter for adjusting the filter coefficient based on the encoding information according to the encoding. The processor 820 may calculate the filter coefficient based on the variable parameter.

FIG. 15 is a flowchart of a method of an encoding device according to some implementations.

Referring to FIG. 15, in operation S310, the encoding device may determine the variable parameter VP for adjusting the filter coefficient FC based on the encoding information EI according to the encoding. In operation S320, the encoding device may calculate the filter coefficient FC based on the variable parameter VP. In operation S330, the encoding device may spatially filter the image data based on the filter coefficient FC. In operation S340, the encoding device may encode the filtered image data.

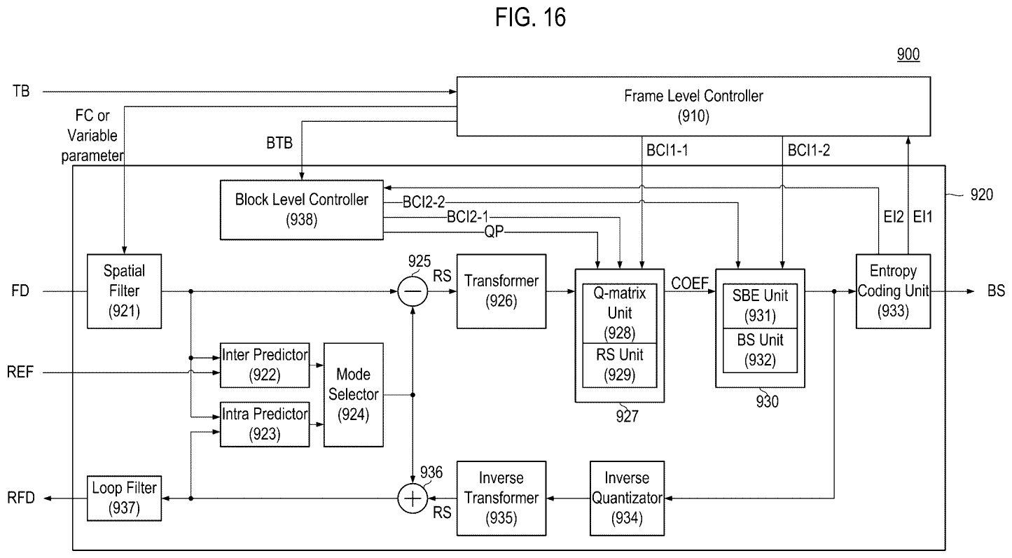

FIG. 16 illustrates an encoding device according to some implementations.

Referring to FIG. 16, an encoding device 900 according to some implementations may include a frame level controller 910 and an encoding unit 920.

The frame level controller 910 may control an overall operation of the encoding unit 920. According to some implementations, the frame level controller 910 may control the encoding unit 920 in units of one image data, that is, one frame.

According to some implementations, the frame level controller 910 may receive first encoding information EI1 from the encoding unit 920 and receive a target bitrate TB from an external device. Based on the first encoding information EI1 and the target bitrate TB, the frame level controller 910 may generate and transmit 1-1st bit control information BCI1-1 for controlling the operation modes of a Q-matrix unit 928 and a rounding offset unit 929 included in a quantizer 927, and may generate and transmit 1-2nd bit control information BCI1-2 for controlling the operation modes of a single bit elimination unit 931 and a block skip unit 932 included in a post-processor 930.

The frame level controller 910 may determine the variable parameter based on the first encoding information EI1. According to some implementations, the frame level controller 910 may transmit the variable parameter to a spatial filter 921. Alternatively, the frame level controller 910 may calculate the filter coefficient FC based on the variable parameter and transmit the filter coefficient to the spatial filter 921.

The encoding unit 920 may perform the encoding on one image data, that is, frame data FD, and output the bit stream BS. According to some implementations, the encoding unit 920 may include the spatial filter 921, an inter predictor 922, an intra predictor 923, a mode selector 924, a subtractor 925, a transformer 926, the quantizer 927, the post-processor 930, an entropy encoding unit 933, an inverse quantizer 934, an inverse transformer 935, an adder 936, a loop filter 937, and a block level controller 938.

The spatial filter 921 may perform the spatial filtering on a current frame data FD, according to the above-described implementations. For example, the spatial filter 921 may adaptively perform the spatial filtering based on the filter coefficient FC controlled by the variable parameter.

The inter predictor 922 may perform inter prediction on the filtered frame data in encoding units, that is, for each block. The inter prediction may mean a prediction method using, for example, a similarity between a current image and another image. Specifically, the inter predictor 922 may determine a prediction sample of a current block by using a block of a reference sample. In the present disclosure, the sample may be a base unit constituting a block. For example, the sample may be a pixel or a pixel value. The inter predictor 922 may detect a reference block similar to the block of the current frame from among reference frame data REF decoded earlier than the current frame data FD and may determine the prediction sample from the reference block.

The intra predictor 923 may perform intra prediction for each block. The intra prediction may mean a processing method using, for example, a spatial similarity in one image. Specifically, the intra predictor 923 may determine the prediction sample of the current block by using the neighboring sample spatially adjacent to the current block.

The mode selector 924 may select the term “inter” or “intra”, depending on the inter mode in which inter prediction is performed or the intra mode in which intra prediction is performed.

The subtractor 925 may output a residual sample RS by subtracting the prediction samples generated by the inter predictor 922 or by the intra predictor 923, from an original sample of the current block.

The transformer 926 may perform conversion on the residual samples RS and output a conversion coefficient.

The quantizer 927 may quantize transform coefficients output from the transformer 926 to output quantized transform coefficients COEF. According to some implementations, the quantizer 927 may include the Q-matrix unit 928 and the rounding offset unit 929, and may perform quantization through the Q-matrix unit 928, or may add the rounding offset to the quantization parameter QP through the rounding offset unit 929.

The post-processor 930 may perform post-processing on the quantized transform coefficients COEF. According to some implementations, the post-processor 930 may include a single bit elimination unit 931 and the block skip unit 932, and may remove a single bit through the single bit elimination unit 931, or may skip some blocks through the block skip unit 932. According to some implementations, the post-processor 930 may be omitted.

The entropy encoding unit 933 may encode post-processed quantized transform coefficients into residual syntax elements including a level value and may output them in the form of the bit stream BS.

The quantized transform coefficients COEF or the quantized transform coefficients post-processed through the post-processor 930 may be inversely quantized and inversely transformed through the inverse quantizer 934 and the inverse transformer 935 to generate residual samples RS again.

An adder 936 may output a restored sample by summing the residual samples RS and the prediction samples. The loop filter 937 may perform deblocking filtering and/or adaptive loop filtering on the restored sample. Restored frame data RFD may finally be output through the loop filter 937.

The block level controller 938 may receive a block target bitrate BTB from the frame level controller 910 and may receive second encoding information EI2 from the entropy encoding unit 933. The block level controller 938 may perform a block level control based on the block target bitrate BTB and the second encoding information EI2.

According to some implementations, the block level controller 938 may determine the quantization parameter QP and transmit the quantization parameter QP to the quantizer 927. The block level controller 938 may generate and transmit 2-1st bit control information BCI2-1 for controlling the operation modes of the Q-matrix unit 928 and the rounding offset unit 929 included in the quantizer 927, and 2-2nd bit control information BCI2-2 for controlling the operation modes of the single bit elimination unit 931 and the block skip unit 932 included in the post-processor 930.

The quantizer 927 may determine the operation mode according to the 1-1st bit control information BCI1-1 and the 2-1st bit control information BCI2-1, and the post-processor 930 may determine the operation mode according to the 1-2nd bit control information BCI1-2 and the 2-2nd bit control information BCI2-2. The operation mode may include at least one of the 1-1st operation mode to the 4-2nd operation mode described above. Accordingly, the quantizer 927 and/or the post-processor 930 may operate in an appropriate operation mode according to the bitrate of the bit stream BS, thereby enabling the bit stream BS to satisfy the target bitrate TB.

According to the above-described implementations, the encoding device 900 of the present disclosure may adaptively adjust the bitrate through the spatial filter 921, the quantizer 927, and the post-processor 930. In particular, there may be a scenario where image quality is required to be maintained while operating at an extremely low target bitrate TB. In this scenario, the encoding device 900 of the present disclosure may maintain image quality and satisfy the target bitrate TB without increasing the quantization parameter QP through adjusting the filter coefficient as well as controlling the bitrate through the quantizer 927 and the post-processor 930.

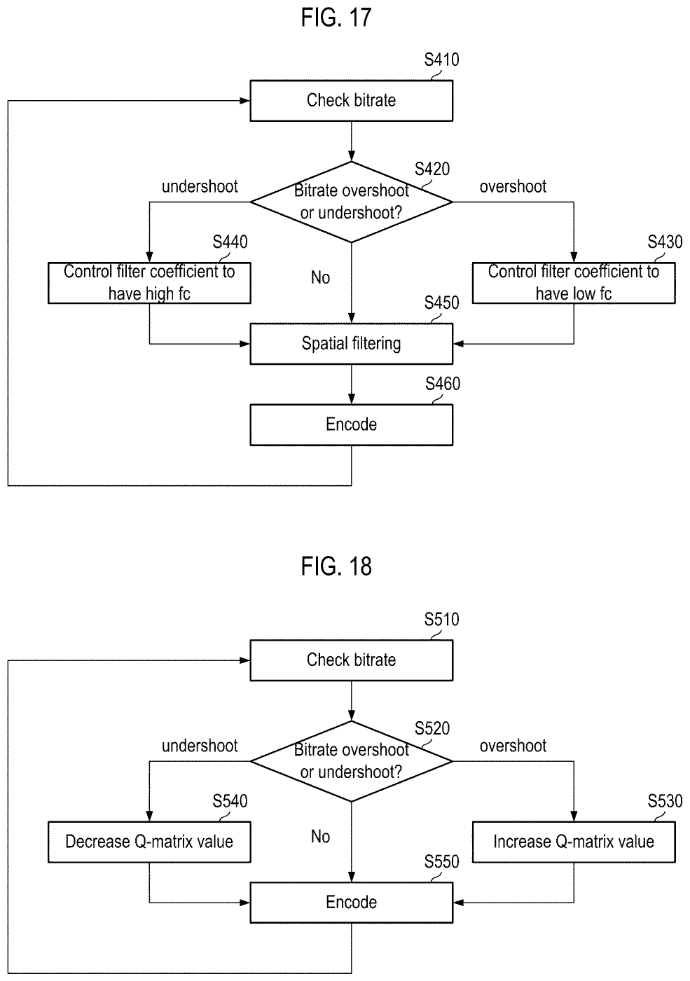

FIG. 17 is a flowchart of a method of an encoding device according to some implementations.

Referring to FIG. 17, in operation S410, the encoding device may determine the bitrate. The encoding device may determine the bitrate of the bit stream through encoding information according to that the encoding on one or more image data is completed.

In operation S420, the encoding device may determine whether the current bitrate is overshot or undershot. For example, the encoding device may determine that the bitrate overshot when the bitrate indicated by the encoding information is greater than the target bitrate, and determine that the bitrate undershot when the bitrate is less than the target bitrate.

When it is determined that the bitrate is overshot, in operation S430, the encoding device may control the filter coefficient so that the filter has a lower cut-off frequency. The control of the filter coefficient may be performed based on adjusting the variable parameter, according to the above-described implementations. For example, the encoding device may make the filter have a low cut-off frequency by further reducing the variable parameter.

When it is determined that the bitrate is undershot, in operation S440, the encoding device may control the filter coefficient so that the filter has a higher cut-off frequency. For example, the encoding device may make the filter have the higher cut-off frequency by further increasing the variable parameter.

When the bitrate is not determined to be overshot or undershot, or when the control of the filter coefficient is terminated, in operation S450, the encoding device may perform the spatial filtering based on the filter coefficient.

In operation S460, the encoding device may perform the encoding on the filtered image data. When the encoding on the one or more image data ends, the encoding device may repeat operation S410 of checking the encoding information according to the encoding.

According to the above-described implementations, the method of the encoding device of the present disclosure may determine whether the bitrate is overshot or undershot based on the encoding information, and adaptively control the filter coefficient FC through the variable parameter according to whether the bitrate is overshot or undershot.

FIG. 18 to FIG. 20 are flowcharts of bit control methods of an encoding device, according to some implementations.

Referring to FIG. 18, in operation S510, the encoding device may check the bitrate, and in operation S520, the overshoot or the undershoot of the bitrate may be determined. When the bitrate is overshot, in operation S530, the encoding device may increase a compression rate by increasing a value of the Q-matrix. Alternatively, when the bitrate is undershot, in operation S540, the encoding device may reduce the compression rate by reducing the value of the Q-matrix. In operation S550, the encoding device may perform the encoding according to the adjusted value of the Q-matrix.

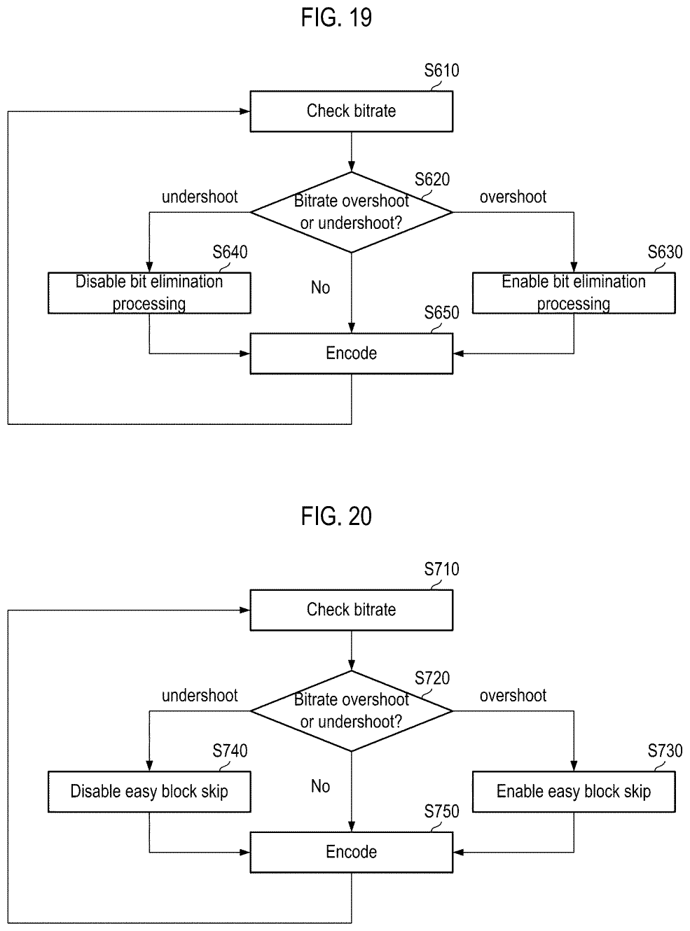

Referring to FIG. 19, in operation S610, the encoding device may check the bitrate, and in operation S620, the overshoot or the undershoot of the bitrate may be determined. When the bitrate is overshot, in operation S630, the encoding device may activate a single bit elimination operation to increase the compression rate. Alternatively, when the bitrate is undershot, in operation S640, the encoding device may deactivate the single bit elimination operation to reduce the compression rate. In operation S650, the encoding device may perform the encoding depending on data in which the single bit is removed or maintained.

Referring to FIG. 20, in operation S710, the encoding device may check the bitrate, and in operation S720, the overshoot or the undershoot of the bitrate may be determined. When the bitrate is overshot, in operation S730, the encoding device may alleviate a block skip condition and increase the compression rate. Alternatively, when the bitrate is undershot, in operation S740, the encoding device may reinforce the block skip condition to reduce the compression rate. In operation S750, the encoding device may perform the encoding depending on data on which the block skip is performed.

According to the present disclosure, an encoding device capable of adaptively adjusting the filter coefficient and the method thereof may be provided.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

The above are specific implementations for implementing the present disclosure. In addition to the above-described implementations, the present disclosure will also include implementations which may be simply designed or easily changed. In addition, the present disclosure will also include techniques which may be easily modified and implemented by using implementations. Therefore, the scope of the present disclosure should not be limited to the above-described implementations, but should be determined not only by the scope of the claims to be described later but also by those equivalent to the claims of the present disclosure.

While the present disclosure has been described with reference to implementations thereof, it will be apparent to those of ordinary skill in the art that various changes and modifications may be made thereto without departing from the spirit and scope of the present disclosure as set forth in the following claims.

What is claimed is:

1. An encoding device comprising:
an encoder configured to spatially filter image data based on a filter coefficient and encode the filtered image data; and
a controller configured to receive encoding information from the encoder and, based on the encoding information, determine a variable parameter for adjusting the filter coefficient.

2. The encoding device of claim 1, wherein the encoder is configured to:
receive the variable parameter from the controller; and
calculate the filter coefficient based on the variable parameter.

3. The encoding device of claim 2, wherein the encoder is configured to calculate the filter coefficient based on adjusting a basic filter setting value and also based on the variable parameter.

4. The encoding device of claim 2, wherein the encoder is configured to apply scaling in calculating the filter coefficient and is configured to apply a shift according to the scaling to the filtered image data.

5. The encoding device of claim 1, wherein the controller is configured to calculate the filter coefficient based on the variable parameter and is configured to transmit the filter coefficient to the encoder.

6. The encoding device of claim 5, wherein the controller is configured to apply scaling in calculating the filter coefficient, and
wherein the encoder is configured to apply a shift according to the scaling to the filtered image data.

7. The encoding device of claim 1, wherein the controller is configured to determine whether a bitrate is overshot or undershot based on the encoding information, configured to reduce the variable parameter based on the bitrate being overshot, and configured to increase the variable parameter based on the bitrate being undershot.

8. The encoding device of claim 1, wherein the filter coefficient is configured to increase a cut-off frequency of the spatial filtering based on the variable parameter increasing, and
wherein the filter coefficient is configured to decrease the cut-off frequency based on the variable parameter decreasing.

9. The encoding device of claim 1, wherein the controller is configured to transmit bit control information to the encoder and configured to control a bitrate, and
wherein the encoder is configured to encode the filtered image data based on the bit control information.

10. The encoding device of claim 9, wherein the controller is configured to determine whether the bitrate is overshot or undershot based on the encoding information, and configured to generate the bit control information according whether the bitrate is overshot or undershot.

11. A method of operating an encoding device, the method comprising:
determining a variable parameter for adjusting a filter coefficient based on encoding information;
calculating the filter coefficient based on the variable parameter;
spatially filtering image data based on the filter coefficient; and
encoding the filtered image data.

12. The method of claim 11, wherein determining the variable parameter includes:
determining whether a bitrate is overshot or undershot based on the encoding information;
reducing the variable parameter based on the bitrate being overshot; and
increasing the variable parameter based on the bitrate being undershot.

13. The method of claim 11, further comprising:
applying scaling in calculating the filter coefficient; and
applying a shift according to the scaling to the filtered image data.

14. The method of claim 11, wherein the filter coefficient is configured to increase a cut-off frequency of the spatial filtering based on the variable parameter increasing, and
wherein the filter coefficient is configured to decrease the cut-off frequency based on the variable parameter decreasing.

15. The method of claim 11, further comprising:
determining whether a bitrate is overshot or undershot based on the encoding information; and
generating bit control information to control the bitrate according to whether the bitrate is overshot or undershot.

16. An encoding device comprising:
a processing device; and
a memory device storing instructions that when executed by the processing device cause the encoding device to perform operations comprising:
determining a variable parameter for adjusting a filter coefficient based on encoding information;
calculating the filter coefficient based on the variable parameter;
spatially filtering image data based on the filter coefficient; and
encoding the filtered image data.

17. The encoding device of claim 16, wherein the operations comprise:
determining whether a bitrate is overshot or undershot based on the encoding information; and
decreasing the variable parameter based on the bitrate being overshot, and
increasing the variable parameter based on the bitrate being undershot.

18. The encoding device of claim 16, wherein the operations comprise:
applying scaling in calculating the filter coefficient; and
applying a shift according to the scaling to the filtered image data.

19. The encoding device of claim 16, wherein the filter coefficient is configured to increase a cut-off frequency of the spatial filtering based on the variable parameter increasing, and
wherein the filter coefficient is configured to decrease the cut-off frequency based on the variable parameter decreasing.

20. The encoding device of claim 16, wherein the operations comprise:
determining whether a bitrate is overshot or undershot based on the encoding information; and
generating bit control information to control the bitrate according to whether the bitrate is overshot or undershot.
